(19) United States
(12) Patent Application Publication
(10) Pub. No.: US 2023/0297314 A1
(43) Pub. Date: Sep. 21, 2023

(54) INFORMATION DISTRIBUTION CONTROL DEVICE, INFORMATION DISTRIBUTION CONTROL METHOD, AND STORAGE MEDIUM

(71) Applicant: NEC Corporation, Tokyo (JP)

(72) Inventor: Koji Hasegawa, Tokyo (JP)

(73) Assignee: NEC Corporation, Tokyo (JP)

(21) Appl. No.: 18/183,643

(22) Filed: Mar. 14, 2023

(30) Foreign Application Priority Data
Mar. 16, 2022 (JP) 2022-040867

(51) Int. Cl. G06F 3/14

(52) U.S. Cl. CPC G06F 3/1454; G06F 3/1407

(57) ABSTRACT

An information distribution control device according to an aspect of the present disclosure includes: at least one memory configured to store instructions; and at least one processor configured to execute the instructions to: distribute, to a terminal device, distribution information in which the terminal device is designated as a distribution destination, the terminal device displaying the received distribution information in a signage region included in a display screen; receive input information indicating an input to the signage region; update the distribution information according to the input information; and distribute the updated distribution information to a terminal device designated as a distribution destination of the distribution information.

This application is based upon and claims the benefit of priority from Japanese Patent Application No. 2022-040867, filed on Mar. 16, 2022, the disclosure of which is incorporated herein in its entirety by reference.

### TECHNICAL FIELD

The present disclosure relates to a technology for controlling distribution of information.

### BACKGROUND ART

JP 2015-225612 A describes an example of a digital signage system. In the digital signage system of JP 2015-225612 A, the signage information server causes a signage device provided with a display device and a mobile terminal of the resident, which are installed in a facility where the resident lives, to display the bulletin information. The signage information server of JP 2015-225612 A further displays a questionnaire or the like on the resident's mobile terminal, and receives answer information from the resident's mobile terminal. The signage information server of JP 2015-225612 A stores the received answer information.

### SUMMARY

An object of the present disclosure is to provide an information distribution control device or the like that can update distribution information on a side of a device that receives the distribution information to be distributed.

An information distribution control device according to an aspect of the present disclosure includes: at least one memory configured to store instructions; and at least one processor configured to execute the instructions to: distribute, to a terminal device, distribution information in which the terminal device is designated as a distribution destination, the terminal device displaying the received distribution information in a signage region included in a display screen; receive input information indicating an input to the signage region; update the distribution information according to the input information; and distribute the updated distribution information to a terminal device designated as a distribution destination of the distribution information.

An information distribution control method according to an aspect of the present disclosure includes: distributing, to a terminal device, distribution information in which the terminal device is designated as a distribution destination, the terminal device displaying the received distribution information in a signage region included in a display screen; receiving input information indicating an input to the signage region; updating the distribution information according to the input information; and distributing the updated distribution information to a terminal device designated as a distribution destination of the distribution information.

A non-transitory computer readable storage medium according to an aspect of the present disclosure stores a program causing a computer to execute: distribution processing of distributing, to a terminal device, distribution information in which the terminal device is designated as a distribution destination, the terminal device displaying the received distribution information in a signage region included in a display screen; input information receiving processing of receiving input information indicating an input to the signage region; and updating processing of updating the distribution information according to the input information, wherein the distribution processing includes distributing updated distribution information to a terminal device designated as a distribution destination of the distribution information.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating an example of a configuration of an information distribution control device according to a first example embodiment of the present disclosure;

FIG. 2 is a flowchart illustrating an example of the operation of the information distribution control device according to the first example embodiment of the present disclosure;

FIG. 3 is a block diagram illustrating an example of a configuration of an information distribution system according to a second example embodiment of the present disclosure;

FIG. 4 is a flowchart illustrating an example of an operation of an information distribution control device according to the second example embodiment of the present disclosure;

FIG. 5 is a block diagram illustrating an example of a configuration of a terminal device according to a third example embodiment of the present disclosure;

FIG. 6 is a flowchart illustrating an example of the operation of the terminal device according to the third example embodiment of the present disclosure;

FIG. 7 is a diagram schematically illustrating signage regions in a first specific example and a second specific example;

FIG. 8 is a diagram illustrating an example of a signage region in which a reply to a message is displayed;

FIG. 9 is a diagram schematically illustrating an example of distribution information which is a template for generating new distribution information;

FIG. 10 is a diagram schematically illustrating another example of the distribution information which is a template for generating new distribution information;

FIG. 11 is a diagram illustrating a specific example of the distribution information to be displayed;

FIG. 12 is a diagram illustrating another specific example of the distribution information to be displayed; and

FIG. 13 is a diagram illustrating an example of a hardware configuration of a computer that can implement the information distribution control device and the terminal device according to the example embodiment of the present disclosure.

### EXAMPLE EMBODIMENT

Hereinafter, example embodiments of the present disclosure will be described.

### First Example Embodiment

First, a first example embodiment of the present disclosure will be described in detail with reference to the drawings.

### Configuration

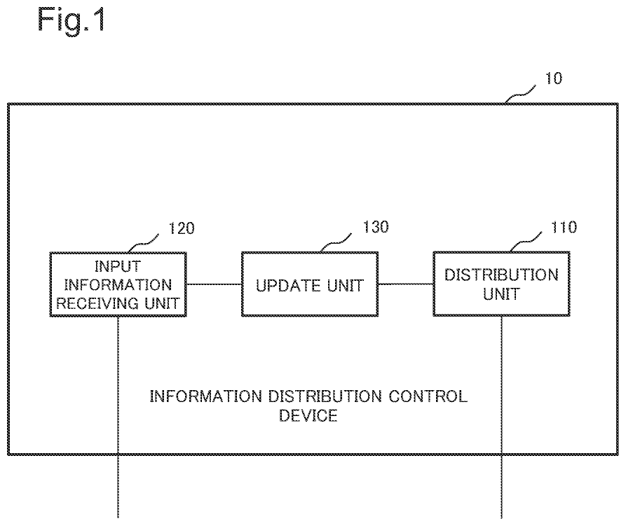

FIG. 1 is a block diagram illustrating an example of a configuration of an information distribution control device according to a first example embodiment of the present disclosure; In the example illustrated in FIG. 1, an information distribution control device 10 of the present example embodiment includes a distribution unit 110, an input information receiving unit 120, and an update unit 130. The distribution unit 110 distributes distribution information in which the terminal device is designated as a distribution destination to a terminal device that displays the received distribution information in a signage region included in a display screen. The input information receiving unit 120 receives input information indicating an input to the signage region. The update unit 130 updates the distribution information according to the input information. The distribution unit 110 distributes the updated distribution information to the terminal device designated as a distribution destination of the distribution information.

The terminal device is connected to the information distribution control device 10. A plurality of terminal devices may be connected to the information distribution control device 10. The terminal device is, for example, a personal computer, a virtual personal computer mounted on a server device, a set top box and a display device connected to the set top box, or a terminal device such as a smartphone. The terminal device receives the distribution information and displays the received distribution information in the signage region. The signage region is a region for displaying the received distribution information included in the display screen of the terminal device. The signage region may be a partial region of the display screen. The terminal device has a function of receiving an input to the signage region by a user of the terminal device. The terminal device transmits the received input information indicating the input to the signage region to the information distribution control device 10. The identification information (hereinafter, also referred to as distribution information identification (ID)) of the distribution information may be added to the distribution information to be transmitted by the update unit 130, for example. The terminal device may associate the distribution information ID assigned to the distribution information displayed in the signage region when receiving the input to the signage region with the input information indicating the received input. The terminal device may transmit the input information associated with the distribution information ID to the information distribution control device 10.

The update of the distribution information may be, for example, a change in the content of the distribution information. The update of the distribution information may be, for example, addition of content of the distribution information. The update of the distribution information may be, for example, new creation of the distribution information. The update of the distribution information may be, for example, addition of a distribution destination of the distribution information. The update of the distribution information may be, for example, deletion of the distribution destination of the distribution information. The update of the distribution information may be, for example, a change of the distribution destination of the distribution information. The update of the distribution information may be, for example, forward of the distribution information. When the update of the distribution information is a change of the distribution destination of the distribution information, the update unit 130 may duplicate the distribution information to be updated and change the distribution destination of the duplicated distribution destination to the changed distribution destination. In other words, the distribution information to be updated and the same new distribution information except for the distribution destination may be generated. In this case, the update unit 130 may further add information indicating forward to the same new distribution information except for the distribution destination.

An attribute may be assigned to the distribution information. The update of the distribution information may be, for example, a change of an attribute of the distribution information. The update of the distribution information is not limited to the above example. A specific example of the above-described update of the distribution information will be described in detail later.

### Operation

Next, an operation of the information distribution control device 10 according to the first example embodiment of the present disclosure will be described in detail with reference to the drawings.

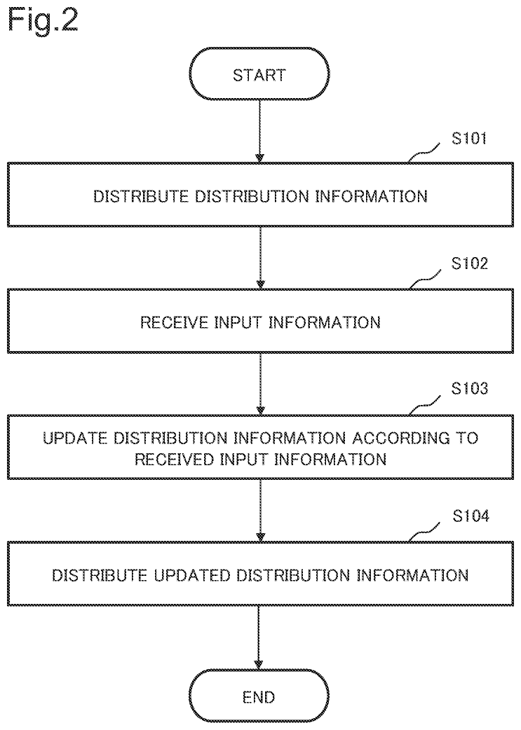

FIG. 2 is a flowchart illustrating an example of the operation of the information distribution control device 10 according to the first example embodiment of the present disclosure. In the example illustrated in FIG. 2, the distribution unit 110 distributes the distribution information (step S101). Specifically, the distribution unit 110 transmits the distribution information to a terminal device designated as a distribution destination of the distribution information. The terminal device receives the distribution information, and displays the received distribution information in a signage region included in the display screen displayed on a display of the terminal device. In a case where there is an input to the signage region, the terminal device receives the input and transmits input information indicating the received input to the information distribution control device 10.

The input information receiving unit 120 receives input information indicating an input to the signage region from the terminal device (step S102). The update unit 130 updates the distribution information according to the received input information (step S103). For example, according to the received input information, the update unit 130 updates the distribution information specified by the distribution information ID associated with the input information.

When the distribution information is updated, the distribution unit 110 distributes the updated distribution information to the terminal device designated as the distribution destination of the updated distribution information (step S104). Then, the information distribution control device 10 ends the operation illustrated in FIG. 2.

### Effects

The present example embodiment described above has an effect that the distribution information can be updated on the side of the device that receives the distribution information to be distributed. The reason is that the input information receiving unit 120 receives the input information from the terminal device, and the update unit 130 updates the distribution information according to the received input information. Therefore, in the present example embodiment, the distribution information can be updated on the side of the device that receives the distributed distribution information. Specifically, for example, in the present example embodiment, it is possible to newly create or update new bulletin information on the side of a device that receives distribution information to be distributed. Further, it is possible to perform communication such as a reply to the transmitted bulletin information or a forward to another member.

### Second Example Embodiment

Next, a second example embodiment of the present disclosure will be described in detail with reference to the drawings.

### Configuration

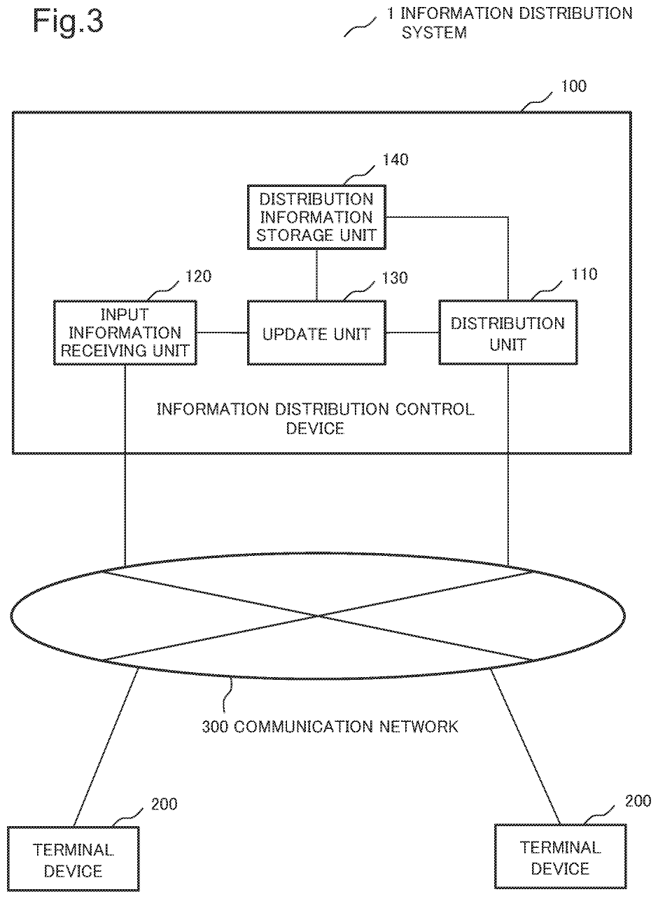

FIG. 3 is a block diagram illustrating an example of a configuration of an information distribution system 1 according to the second example embodiment of the present disclosure. In the example illustrated in FIG. 3, the information distribution system 1 includes an information distribution control device 100 and a plurality of terminal devices 200. The information distribution control device 100 is communicably connected to each of the plurality of terminal devices 200 via a communication network 300.

The information distribution control device 100 includes a distribution unit 110, an input information receiving unit 120, an update unit 130, and a distribution information storage unit 140. The distribution unit 110, the input information receiving unit 120, and the update unit 130 have the same functions as the functions of the distribution unit 110, the input information receiving unit 120, and the update unit 130 of the first example embodiment, respectively. The distribution unit 110, the input information receiving unit 120, and the update unit 130 perform the same operations as the operations of the distribution unit 110, the input information receiving unit 120, and the update unit 130 of the first example embodiment, respectively. The distribution unit 110, the input information receiving unit 120, and the update unit 130 will be described in more detail later.

### Terminal Device 200

The terminal device 200 has the same configuration as that of the 20 terminal device of the first example embodiment. As described above, the terminal device 200 receives the distribution information and displays the received distribution information in the signage region described above. The terminal device 200 has a function of receiving an input to the signage region by a user of the terminal device 200. The terminal device 200 transmits the received input information indicating the input to the signage region to the information distribution control device 100. As described above, the identification information (hereinafter, the distribution information ID) of the distribution information may be assigned to the distribution information to be transmitted by the update unit 130, for example. The terminal device 200 may associate the distribution information ID assigned to the distribution information displayed in the signage region when receiving the input to the signage region with the input information indicating the received input. The terminal device 200 may transmit the input information associated with the distribution information ID to the information distribution control device 100.

For example, at the time of activation, the terminal device 200 may request the information distribution control device 100 to distribute the distribution information. In this case, the terminal device 200 may request the distribution of all the distribution information in which the terminal device 200 is designated as the distribution destination. The terminal device 200 may request the distribution of the distribution information updated after the previous distribution among all the distribution information in which the terminal device 200 is designated as the distribution destination. In this case, when requesting the distribution of the distribution information, the terminal device 200 may transmit the information of the date and time of the previous distribution to the information distribution control device 100 together with the distribution request of the distribution information. The terminal device 200 may hold the date and time of the previous distribution.

The terminal device 200 may request the information distribution control device 100 to distribute the distribution information, for example, when a request for distribution of the distribution information is instructed by an operation of a user of the terminal device 200. In a case where the request for distribution of all the distribution information is instructed, the terminal device 200 requests distribution of all the distribution information of which the terminal device 200 is designated as the distribution destination. In a case where the request for distribution of the distribution information updated after the previous distribution is instructed, the terminal device 200 requests distribution of the distribution information updated after the previous distribution among all the distribution information in which the terminal device 200 is designated as the distribution destination. In this case, when requesting the distribution of the distribution information, the terminal device 200 transmits the information of the date and time of the previous distribution to the information distribution control device 100 together with the distribution request of the distribution information. The terminal device 200 may hold the date and time of the previous distribution. The operation of instructing the distribution request of all the distribution information may be an appropriately determined operation. The operation of instructing the distribution request of the distribution information updated after the previous distribution may be an appropriately determined operation different from the operation of instructing the distribution request of all the distribution information.

In a case where the request to transmit the specific distribution information is instructed, the terminal device 200 transmits the distribution information ID of the distribution information requested to be distributed to the information distribution control device 100 together with the request to distribute the distribution information when requesting the distribution of the distribution information. In this case, the distribution information displayed in the signage region may include information indicating other distribution information to be referred to. Such distribution information may include a distribution information ID of the distribution information to be referred to as information indicating other distribution information to be referred to (hereinafter, also referred to as reference information). Then, when displaying the distribution information including the information indicating the reference information in the signage region, the terminal device 200 may display the reference information in the signage region. In the signage region, the reference information may be represented by, for example, at least one of a figure, a character, a character string, and the like. For example, in a case where an operation of designating the reference information is performed on the display indicating the reference information of the signage region, the terminal device 200 may determine that the request for distribution of the distribution information indicated by the reference information is instructed. Then, the terminal device 200 may specify the distribution information ID of the distribution information for which the distribution request is instructed, and request the distribution of the distribution information represented by the specified distribution information ID. The operation of designating the reference information may be appropriately determined for each input device of the terminal device 200. The operation of designating the reference information may be, for example, selection of a display indicating the reference information by a mouse, tapping on a display indicating the reference information displayed on a touch panel, or the like. The operation of designating the reference information is not limited to these examples. The instruction of the request to transmit the specific distribution information is not limited to the above example.

### Information Distribution Control Device 100

### Distribution Information Storage Unit 140

The distribution information storage unit 140 stores distribution information. The distribution information may be associated with information (for example, a terminal ID which is an identifier of the terminal device 200) of the terminal device 200 designated as the distribution destination of the distribution information. The distribution information may include a terminal ID of the terminal device 200 designated as a distribution destination of the distribution information. The distribution information may include a plurality of types of information such as text, image (that is, a still image), moving image, and audio. A format specification may be added to the text included in the distribution information. The distribution information may include reference to other distribution information. The reference information of the distribution information may include the distribution information ID of the distribution information. The distribution information storage unit 140 may store the date and time of update of the distribution information for each distribution information. The distribution information storage unit 140 may store information on the date and time when the distribution information has been distributed last for each terminal device 200.

### Distribution Unit 110

The distribution unit 110 reads the distribution information from the distribution information storage unit 140, and distributes the read distribution information to the terminal device 200 designated as the distribution destination of the distribution information. The distribution unit 110 may distribute the terminal ID of the terminal device 200 designated as the distribution destination of the distribution information together with the distribution information.

For example, when the distribution information stored in the distribution information storage unit 140 is updated, the distribution unit 110 transmits the updated distribution information to the terminal device 200 designated as the distribution destination of the distribution information. In this case, the update unit 130 to be described in detail later may notify the distribution unit 110 of the updated distribution information (specifically, the distribution information ID of the updated distribution information). For example, the distribution unit 110 may monitor the update of the distribution information stored in the distribution information storage unit 140. In a case where the update of the distribution information is detected, the distribution unit 110 may transmit the updated distribution information to the terminal device 200 designated as the distribution destination of the distribution information.

In a case where the input information receiving unit 120 to be described in detail later receives a distribution request of the distribution information from the terminal device 200, the distribution unit 110 distributes the distribution information requested to be distributed to the terminal device 200 that has transmitted the distribution request. In this case, when receiving the distribution request of the distribution information from the terminal device 200, the input information receiving unit 120 sends the received request to the distribution unit 110 via, for example, the update unit 130. When receiving the distribution request of the distribution information from the terminal device 200, the input information receiving unit 120 may directly send the received request to the distribution unit 110. In FIG. 3, a line directly connecting the input information receiving unit 120 and the distribution unit 110 is omitted in order to prevent complication of the drawing.

In a case where distribution of all the distribution information is requested by the distribution request, the distribution unit 110 distributes all the distribution information in which the terminal device 200 that has transmitted the distribution request is designated as the distribution destination to the terminal device 200 that has transmitted the distribution request.

In a case where the distribution of the distribution information updated after the previous distribution is requested by the distribution request, the distribution unit 110 distributes the distribution information updated after the previous distribution among the distribution information in which the terminal device 200 that has transmitted the distribution request is designated as the distribution destination to the terminal device 200. The information indicating the date and time of the previous distribution may be included in the distribution request. As described above, the information indicating the date and time of the previous distribution may be stored in the distribution information storage unit 140. In this case, the distribution unit 110 may read the date and time of the previous distribution to the terminal device 200 that has transmitted the distribution request from the distribution information storage unit 140. Then, in a case where the distribution unit 110 distributes the distribution information to the terminal device 200, the distribution unit stores information of the date and time when the distribution information is distributed in the distribution information storage unit 140 for each terminal device 200.

In a case where the distribution of the specific distribution information is requested by the distribution request, the distribution unit 110 reads the distribution information requested to be distributed from the distribution information storage unit 140. Then, the distribution unit 110 distributes the read distribution information to the terminal device 200 that has transmitted the distribution request of the distribution information.

### Input Information Receiving Unit 120

The input information receiving unit 120 receives input information indicating an input to the signage region from the terminal device 200. The input information is, for example, input information for updating the distribution information. The input information may be, for example, a request for distribution of the distribution information. The input information receiving unit 120 sends the received input information to the update unit 130.

In a case where the input information is a request for distribution of the distribution information, the input information receiving unit 120 may directly send the received input information to the distribution unit 110.

### Update Unit 130

The update unit 130 receives the input information received by the input information receiving unit 120 from the input information receiving unit 120. In a case where the received input information is input information for updating the distribution information, the update unit 130 updates the distribution information stored in the distribution information storage unit 140 according to the input information. The update unit 130 may notify the distribution unit 110 of the information of the updated distribution information.

In a case where the received input information is a request for distribution of the distribution information, the update unit 130 sends the received input information to the distribution unit 110.

### Operation

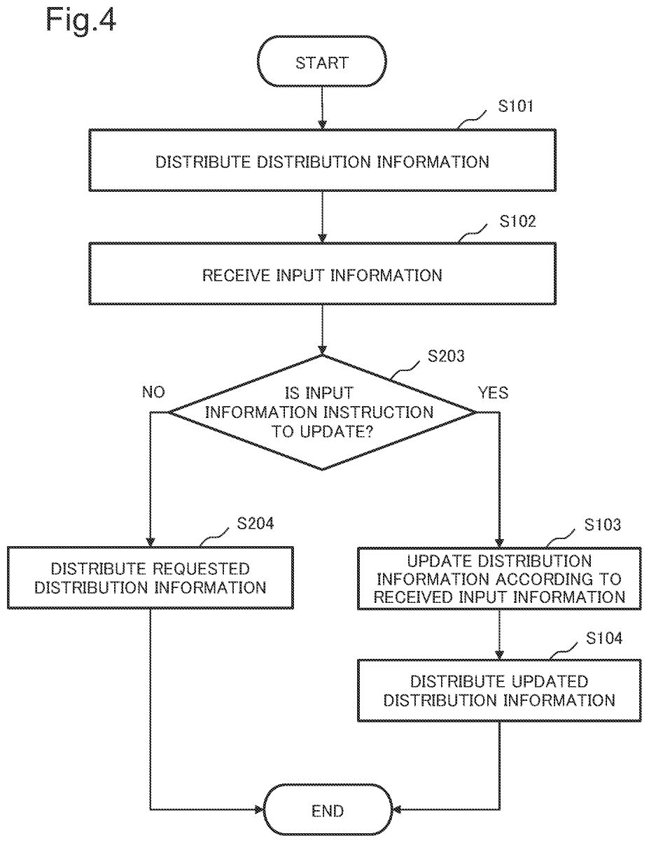

FIG. 4 is a flowchart illustrating an example of the operation of the information distribution control device 100 according to the second example embodiment of the present disclosure. In the example illustrated in FIG. 4, the distribution unit 110 distributes the distribution information (step S 101). Specifically, the distribution unit 110 transmits the distribution information to a terminal device designated as a distribution destination of the distribution information. The terminal device receives the distribution information, and displays the received distribution information in a signage region included in the display screen displayed on a display of the terminal device. In a case where there is an input to the signage region, the terminal device receives the input and transmits input information indicating the received input to the information distribution control device 10.

The input information receiving unit 120 receives input information indicating an input to the signage region from the terminal device (step S102).

When the received input information is an instruction to update (YES in step S203), the update unit 130 updates the distribution information according to the received input information (step S103). For example, according to the received input information, the update unit 130 updates the distribution information specified by the distribution information ID associated with the input information.

When the distribution information is updated, the distribution unit 110 distributes the updated distribution information to the terminal device designated as the distribution destination of the updated distribution information (step S 104). Then, the information distribution control device 100 ends the operation illustrated in FIG. 4.

In the present example embodiment, the input information is an update instruction (specifically, an instruction to update the distribution information) or a distribution request of the distribution information. When the received input information is a request for distribution of the distribution information (NO in step S203), the distribution unit 110 distributes the requested distribution information (step S204). Then, the information distribution control device 100 ends the operation illustrated in FIG. 4.

### Effects

The present example embodiment described above has the same effect as the effect of the first example embodiment. The reason is the same as the reason why the effect of the first example embodiment occurs.

### Third Example Embodiment

Next, a third example embodiment of the present disclosure will be described in detail with reference to the drawings.

### Configuration

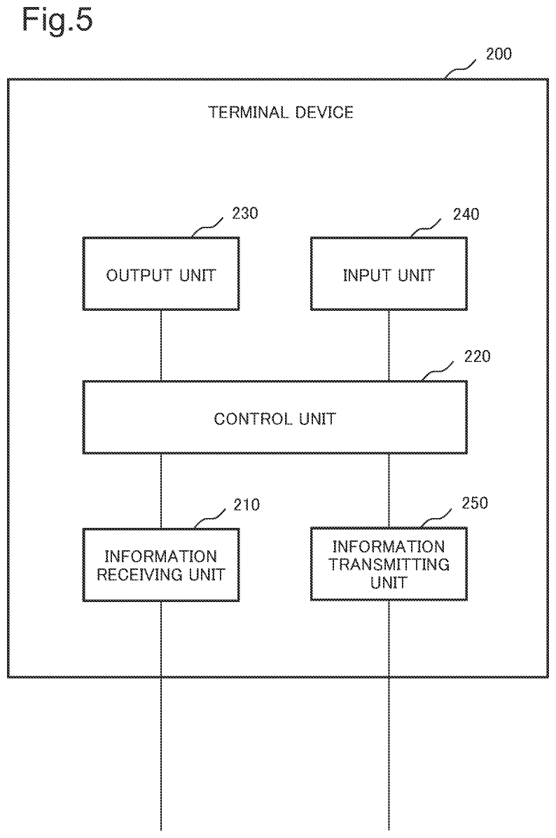

FIG. 5 is a block diagram illustrating an example of a configuration of a terminal device 200 according to the third example embodiment of the present disclosure. The example illustrated in FIG. 5 includes an information receiving unit 210, a control unit 220, an output unit 230, an input unit 240, and an information transmitting unit 250. The information distribution control device 100 in the following description is the information distribution control device 100 according to the second example embodiment described above. The terminal device 200 of the present example embodiment operates as the terminal device 200 of the second example embodiment.

### Information Receiving Unit 210

The information receiving unit 210 receives the distribution information from the information distribution control device 100. The information receiving unit 210 sends the received distribution information to the control unit 220.

### Control Unit 220

The control unit 220 receives the distribution information from the information receiving unit 210. The control unit 220 outputs the received distribution information to the output unit 230. Specifically, when the received distribution information includes information that can be displayed on a screen such as a text and an image, the control unit 220 generates a display screen in which the displayable information among the distribution information is displayed in the signage region. The control unit 220 displays the generated display screen on the output unit 230. In a case where the distribution information includes a voice or the like, the control unit 220 generates a display screen including a signage region on which a display indicating the voice or the like is displayed, and outputs the generated display screen to the output unit 230. Then, when the control unit 220 receives an input indicating an instruction to reproduce a voice or the like by the user via the input unit 240, the control unit outputs the voice or the like to the output unit 230 according to the received instruction.

The control unit 220 receives an input by a user's operation from input unit 240. The control unit 220 generates input information from the received input. Specifically, for example, in a case where the received input is a request for distribution information, the control unit 220 generates input information indicating the request for distribution information. In a case where the received input is the update of the distribution information, the control unit 220 generates the input information indicating the update of the distribution information. The control unit 220 sends the generated input information to the information transmitting unit 250.

### Output Unit 230

The output unit 230 includes, for example, a display device such as a display or a touch panel. The output unit 230 displays the signage region under the control of the control unit 220. The output unit 230 may include an audio output device such as a speaker.

### Input Unit 240

The input unit 240 is, for example, an input device such as a keyboard and a mouse, or a touch panel. The input unit 240 receives an input to the signage region.

### Information Transmitting Unit 250

The information transmitting unit 250 receives input information from the control unit 220. The information transmitting unit 250 transmits the received input information to the information distribution control device 100.

### Operation

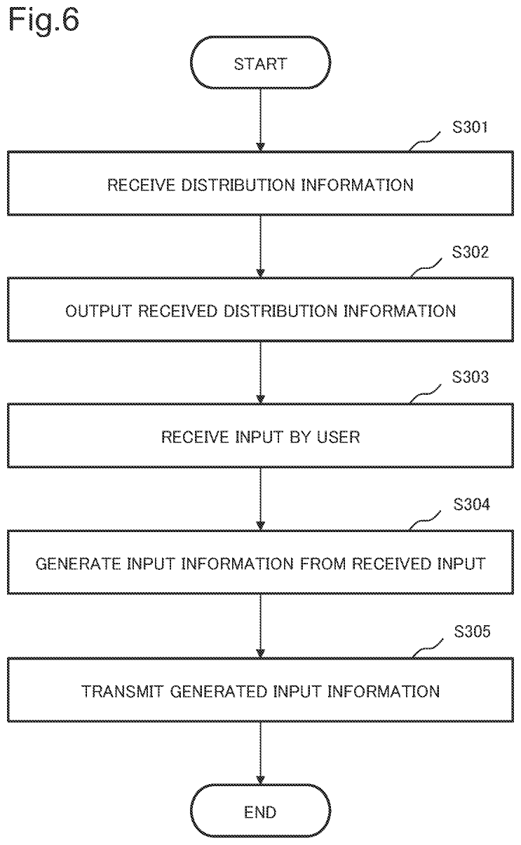

FIG. 6 is a flowchart illustrating an example of the operation of the terminal device 200 according to the third example embodiment of the present disclosure. In the example illustrated in FIG. 6, the information receiving unit 210 receives the distribution information from the information distribution control device 100 (step S301). Next, the control unit 220 outputs the received distribution information to the output unit 230 (step S302). Specifically, for example, the control unit 220 generates a display screen in which the received distribution information is displayed in the signage region, and outputs the generated display screen to the output unit 230.

In a case where the user of the terminal device 200 performs an operation on the signage region using the input unit 240, the control unit 220 receives an input by the user input by the operation from the input unit 240 (step S303). The control unit 220 generates input information from the received input (step S304). The information transmitting unit 250 transmits the generated input information to the information distribution control device 100 (step S305).

### Effects

The present example embodiment described above has an effect that the distribution information can be updated on the side of the device that receives the distribution information to be distributed. This is because the control unit 220 generates input information indicating an instruction to update the terminal device. This is because the information transmitting unit 250 transmits the generated input information to the information distribution control device 100 that updates the distribution information according to the received input information when receiving the input information indicating the instruction to update the terminal device.

### First Detailed Example

Hereinafter, a first detailed example of the present disclosure will be described. The configuration of the terminal device 200 of the present detailed example is the same as the configuration of the terminal device 200 of the third example embodiment illustrated in FIG. 5. The basic operation of the terminal device 200 of the present detailed example is the same as the configuration of the terminal device 200 of the third example embodiment illustrated in FIG. 6. The information distribution control device 100 of the present detailed example is the same as the information distribution control device 100 of the second example embodiment. In the present detailed example, the control unit 220 of the terminal device 200 changes the output mode of the output distribution information according to the operation of the user using the input unit 240, for example, as follows. In the present detailed example, in a case where a plurality of pieces of distribution information is received, the control unit 220 switches the output distribution information, for example, as follows according to the operation of the user using the input unit 240.

As described above, when the received distribution information includes information that can be displayed on a screen such as a text and an image, the control unit 220 generates a display screen in which the displayable information among the distribution information is displayed in the signage region. The control unit 220 displays the generated display screen on the output unit 230.

In a case where the distribution information includes information that changes with the lapse of time, such as a moving image and audio, and information that cannot be displayed on the display device (hereinafter, referred to as reproduction information), the control unit 220 may generate a display screen on which an interface for reproducing the reproduction information is displayed in the signage region. Then, in a case where the user gives an instruction to reproduce the reproduction information by operating the input unit 240, the control unit 220 receives, as an input, the instruction given by the operation performed by the user. When receiving the input, the control unit 220 starts reproduction (that is, the reproduction information is output to the output unit 230) of the reproduction information. The control unit 220 may display an interface for stopping reproduction of the reproduction information being reproduced. The control unit 220 may generate a display screen on which an interface of another operation (fast-forward, slow playback, etc.) performed for reproduction of a moving image and audio is displayed in the signage region. Then, in a case where an instruction to perform another operation on which the interface is displayed by the user operating the input unit 240 is received as an input, the control unit 220 may execute the instructed operation.

In a case where the distribution information includes a plurality of types of data (for example, text, still image, moving image, audio, and the like), a display screen including a signage region in which a predetermined type of data (for example, text) and an interface for displaying or reproducing another predetermined type of data are displayed is generated. The above-described predetermined type of data (hereinafter, it is also referred to as display target data) is, for example, text. The other predetermined type of data (hereinafter, it is also referred to as reproduction target data) is, for example, a still image, a moving image, a sound, or the like. The still image may be included in the display target data instead of the reproduction target data. In a case where an instruction to reproduce the reproduction target data by the operation of the user using the input unit 240 is received as an input, the control unit 220 outputs the reproduction target data instructed to be reproduced to the output unit 230. In a case where the distribution information includes a plurality of pieces of reproduction target data, the control unit 220 may generate a display screen including a signage region in which an interface for selecting one piece of reproduction target data from the plurality of pieces of reproduction target data is displayed. In a case where the instruction to select the reproduction target data and the instruction to reproduce the reproduction target data by the operation of the user using the input unit 240 are received as inputs, the control unit 220 outputs the selected reproduction target data to the output unit 230.

The reproduction target data may be associated with the distribution information of the display target data. Specifically, the distribution information of the reproduction target data may be associated with the distribution information of the display target data. When receiving the distribution information of the display target data associated with the distribution information of the reproduction target data, the control unit 220 may generate a display screen including a signage region in which the display target data and an interface for reproducing the related reproduction target data are displayed. In a case where an instruction to reproduce the reproduction target data by the operation of the user using the input unit 240 is received as an input, the control unit 220 generates input information indicating a request for distribution of the distribution information of the reproduction target data instructed to be reproduced. The information transmitting unit 250 transmits the generated input information to the information distribution control device 100. The information distribution control device 100 (specifically, the distribution unit 110) transmits the distribution information of the reproduction target data requested to be distributed by the received input information to the terminal device 200 that has transmitted the input information. The control unit 220 receives the distribution information of the reproduction target data via the information receiving unit 210, and outputs the reproduction target data of the received distribution information to the output unit 230.

In a case where a plurality of pieces of reproduction target data is associated with the distribution information of the display target data, a display screen including a signage region in which an interface for selecting one piece of reproduction target data from the plurality of pieces of reproduction target data is displayed may be generated. In a case where the instruction to select the reproduction target data and the instruction to reproduce the reproduction target data by the operation of the user using the input unit 240 are received as inputs, the control unit 220 generates input information indicating a request for distribution of the distribution information of the selected reproduction target data. Similarly, the information transmitting unit 250 transmits the generated input information to the information distribution control device 100. The information distribution control device 100 (specifically, the distribution unit 110) transmits the distribution information of the reproduction target data requested to be distributed by the received input information to the terminal device 200 that has transmitted the input information. The control unit 220 receives the distribution information of the reproduction target data via the information receiving unit 210, and outputs the reproduction target data of the received distribution information to the output unit 230.

In a case where a plurality of pieces of distribution information is distributed, the control unit 220 may sort the distribution information according to a predetermined sorting rule. Then, the control unit 220 may select the distribution information to be displayed from the plurality of pieces of distribution information according to a predetermined selection rule. The distribution information selected as the distribution information to be displayed is hereinafter referred to as selected distribution information. The control unit 220 may generate a display screen including a signage region in which the distribution information to be displayed and the interface for changing the selected distribution information are displayed.

The above-described sorting rule may be, for example, arranging a plurality of pieces of distribution information in order of earliest generation date and time. The sorting rule may be, for example, arranging a plurality of pieces of distribution information in order of later generation date and time. The sorting rule may be, for example, arranging a plurality of pieces of distribution information in order of the earlier receipt date and time. The sorting rule may be, for example, arranging a plurality of pieces of distribution information in order of later date and time of receipt. A plurality of levels of importance may be assigned to the distribution information. In this case, the sorting rule may be to arrange the distribution information in order of importance. In this case, the sorting rule may include arranging the distribution information of the same importance in order of generation. The sorting rule may include arranging the distribution information of the same importance in order of receipt. The sorting rule is not limited to these examples.

The control unit 220 may generate a display screen including a signage region on which an interface for selecting a sorting rule is displayed. Then, the control unit 220 may receive an input indicating an operation in which the user selects a sorting rule using the input unit 240, and sort the distribution information according to the selected sorting rule indicated by the received input.

The above-described selection rule may be selecting distribution information whose generation date and time is the latest. The selection rule may be selecting distribution information whose generation date and time is the oldest. The selection rule may be selecting distribution information whose pickup date and time is the latest. The selection rule may be selecting distribution information whose pickup date and time is the oldest. The control unit 220 may store undisplayed information indicating whether the distribution information is undisplayed. The selection rule may be selecting distribution information whose generation date and time is the latest among the distribution information that is not displayed. The selection rule may be selecting distribution information whose generation date and time is the oldest among the distribution information that is not displayed. The selection rule may be selecting distribution information whose pickup date and time is the latest among the distribution information that is not displayed. The selection rule may be selecting distribution information whose pickup date and time is the oldest among the distribution information that is not displayed. The display rule is not limited to the above example.

The control unit 220 may generate a display screen including a signage region in which an interface for selecting a display rule is displayed. Then, the control unit 220 may receive an input indicating an operation of the user to select a display rule using the input unit 240, and select the selected distribution information according to the selected display rule indicated by the received input.

In a case where there is undisplayed distribution information, the control unit 220 may generate a display screen including a signage region on which a display indicating that there is the undisplayed distribution information is displayed. The undisplayed distribution information represents distribution information that is not displayed among the already received distribution information and the newly received distribution information. In a case where all the undisplayed distribution information is displayed, the control unit 220 may change the display indicating that the undisplayed distribution information exists in the signage region to the display indicating that the undisplayed distribution information does not exist. The display indicating that the undisplayed distribution information exists may be represented by, for example, a graphic of a predetermined shape of a predetermined color, a predetermined character string, or a combination thereof. The display indicating that the undisplayed distribution information does not exist may be represented by, for example, a graphic of a predetermined shape of a predetermined color, a predetermined character string, a combination thereof, or the like different from the display indicating that the undisplayed distribution information exists. The display indicating that the undisplayed distribution information does not exist may be not displaying the display indicating that the undisplayed distribution information exists. In a case where the input indicating that the user has performed the operation of ending the display indicating that the undisplayed distribution information exists is received, the control unit 220 may change the display indicating that the undisplayed distribution information exists to the display indicating that the undisplayed distribution information does not exist. The user's operation of ending the undisplayed display is, for example, a click or a tap on a displayed portion indicating that the undisplayed distribution information exists.

When receiving the new distribution information, the control unit 220 may generate a display screen including a signage region in which a display indicating that the new distribution information exists is displayed. The new distribution information indicates the newly received distribution information. The newly received distribution information is, for example, distribution information of which a period after the reception is less than a predetermined period. The newly received distribution information may be distribution information received after a predetermined timing. The predetermined timing is, for example, a timing at which the terminal device 200 is powered on, a timing at which the input information indicating the distribution request of the distribution information input by the user is transmitted to the information distribution control device 100, and the like. In a case where all the new distribution information is displayed, the control unit 220 may change the display indicating that the new distribution information exists in the signage region to the display indicating that the new distribution information does not exist. The display indicating that the new distribution information exists may be represented by, for example, a graphic of a predetermined shape of a predetermined color, a predetermined character string, or a combination thereof. The display indicating that the new distribution information does not exist may be represented by, for example, a graphic of a predetermined shape of a predetermined color, a predetermined character string, a combination thereof, or the like different from the display indicating that the new distribution information exists. The display indicating that the new distribution information does not exist may be not displaying the display indicating that the new distribution information exists. In a case where the input indicating that the user has performed the operation of ending the display in which the new distribution information exists is received, the control unit 220 may change the display indicating that the new distribution information exists to the display indicating that the new distribution information does not exist. The user's operation of ending the new display is, for example, a click or a tap on a portion of the display indicating that the new distribution information exists.

In a case where other distribution information is associated with the distribution information (that is, when the distribution information refers to the reference information, in other words, when the distribution information includes the distribution information ID of the reference information), the control unit 220 may display an interface for requesting the other distribution information. Such an interface may be represented by, for example, a graph, a character string, or the like indicating other distribution information. In a case where an input indicating an operation on the interface for requesting other distribution information is received from the input unit 240, the control unit 220 generates input information for requesting other distribution information requested by the interface on which the operation indicated by the input has been performed. The control unit 220 sends the generated input information to the information transmitting unit 250. The information transmitting unit 250 transmits the information to the information distribution control device 100.

The control unit 220 may generate a display screen including a signage region in which an interface (hereinafter, referred to as a list-state switching interface) for switching between a state of displaying the list of the distribution information and a state of displaying the selected distribution information is displayed. In a case where an input indicating an operation on the list-state switching interface is received from the input unit 240 while the selected distribution information is displayed in the signage region, the control unit 220 generates a display screen including the signage region in which a list of the distribution information is displayed. The control unit 220 may generate a display screen including a signage region in which a list of distribution information to which a scroll bar is added is displayed. Then, in a case where an input indicating an operation on the scroll bar is received from the input unit 240, the control unit 220 generates a display screen including a signage region in which a list of distribution information scrolled according to the operation is displayed. In a case where an input indicating an operation of selecting the distribution information from the list of the distribution information is received from the input unit 240, the control unit 220 changes the distribution information which is selected to the selected distribution information.

In a case where an input indicating an operation on the list-state switching interface is received from the input unit 240 while the list of the distribution information is displayed in the signage region, the control unit 220 generates a display screen including the signage region in which the selected distribution information is displayed.

The control unit 220 may generate a display screen including a signage region on which an interface (hereinafter, referred to as a guide interface) for using an artificial intelligence (AI) concierge is displayed. In a case where an input indicating an operation on the guide interface is received from the input unit 240, the control unit 220 may display a user interface for accepting a question or the like in the signage region. In this case, the control unit 220 transmits information such as a question input via a user interface that accepts a question or the like to a server implemented to provide an answer to the question using the AI technology. Then, the control unit 220 receives data of an answer to the question from the server, and displays the received data of the answer in the signage region. A server that provides answers to questions using techniques of AI may be implemented using one of a variety of existing techniques. The information distribution control device 100 may operate as such a server. The operation for ending the use of the AI concierge may be appropriately determined. In a case where an input indicating an operation for ending the use of the AI concierge is received from the input unit 240, the control unit 220 generates a display screen including a signage region on which the selected distribution information is displayed.

### Second Detailed Example

Hereinafter, a second detailed example of the present disclosure will be described. The configuration of the terminal device 200 of the present detailed example is the same as the configuration of the terminal device 200 of the third example embodiment illustrated in FIG. 5. The basic operation of the terminal device 200 of the present detailed example is the same as the configuration of the terminal device 200 of the third example embodiment illustrated in FIG. 6. The information distribution control device 100 of the present detailed example is the same as the information distribution control device 100 of the second example embodiment.

In the present detailed example, the distribution information includes designation of a display mode (for example, the position where the text is displayed, the font of the text, the shape and position of the interface, and the like) in the signage region. The control unit 220 of the terminal device 200 generates a display screen including the signage region in which the distribution information is displayed according to the specification of the mode included in the distribution information. Then, the control unit 220 of the terminal device 200 generates input information indicating an operation on the signage region. The input information is transmitted to the update unit 130 via the information transmitting unit 250 of the terminal device 200 and the input information receiving unit 120 of the information distribution control device 100. The update unit 130 of the information distribution control device 100 specifies the operation indicated by the input information. In a case where the specified operation is a request for updating the distribution information, the update unit 130 updates the distribution information according to the request indicated by the specified operation. In a case where the specified operation is a distribution request of the distribution information, the update unit 130 notifies the distribution unit 110 of the distribution information ID of the distribution information requested to be distributed. The distribution unit 110 reads, from the distribution information storage unit 140, the distribution information indicated by the notified distribution information ID and requested to be distributed, and transmits the read distribution information to the terminal device 200 that has transmitted the input information.

The operation on the signage region in which the interface is displayed is, for example, any of the operation to reproduce or stop the reproduction target data, the operation to switch the selected distribution information, the operation to change the sorting rule, the operation to change the display rule, and the like described above. The operation on the signage region in which the interface is displayed may be, for example, an operation of switching between a state of displaying a list of the distribution information and a state of displaying the target distribution information. The operation on the signage region where the interface is displayed may be, for example, an operation on the guide interface described above.

In a case where the input information receiving unit 120 receives, from the terminal device 200, input information indicating an operation for instructing reproduction of reproduction target data, the distribution unit 110 distributes the distribution target data instructed to be reproduced by the input information to the terminal device 200 that has transmitted the input information. The distribution target data to be distributed may be distributed in the form of distribution information. In a case where the input information receiving unit 120 receives, from the terminal device 200, input information indicating an operation for instructing to stop reproduction of reproduction target data, the distribution unit 110 stops distribution of the distribution target data instructed to stop reproduction by the input information.

In the present detailed example, the distribution unit 110 distributes the distribution information (that is, the selected distribution information) selected as the distribution information to be displayed. Then, in a case where the input information receiving unit 120 receives, from the terminal device 200, the input information indicating the request for distribution of the distribution information other than the selected distribution information, the distribution unit 110 distributes the distribution information requested by the input information to the terminal device 200 that has transmitted the input information. In a case where the input information receiving unit 120 receives, from the terminal device 200, the input information indicating the instruction to switch the selected distribution information selected from the plurality of distribution information, the distribution unit 110 transmits the selected distribution information after the switching to the terminal device 200 that has transmitted the input information.

In the present detailed example, the update unit 130 generates the distribution information designating the mode of the signage region generated by the control unit 220 in the first detailed example. Then, the mode of the distribution information distributed to the terminal device 200 is updated using the input information of the input indicating the operation by the user of the terminal device 200 such that the signage region is changed similarly to the change of the signage region by the control unit 220 of the first detailed example. One of the changes of the signage region is, for example, a change from a display indicating that undisplayed distribution information exists to a display indicating that undisplayed distribution information does not exist. One of the changes of the signage region is, for example, a change from a display indicating that new distribution information exists to a display indicating that new distribution information does not exist.

### Specific Example of Distribution Information

Specific examples of the distribution information and the update of the distribution information will be described below.

### First Specific Example

The distribution information may be a message. The message is distributed to, for example, the terminal device 200 managed by a person belonging to a specific group. The specific group may be, for example, a department of a company. The specific group may be a group of people who perform a specific project. The specific group may be, for example, a group of people who live or move in a specific area, building, floor, or the like. The specific group is not limited to these examples.

The message may be a message for communication such as notification, guidance, or questionnaire. The message may be represented by at least a part of text, image, voice, and the like.

The distribution information that is a message may be associated with distribution information of other information (for example, detailed information of the content of the message, voice information).

In this case, the input may be an answer to the message. Specifically, the input may be an operation for starting creation of an answer to the message displayed in the signage region and an operation for inputting the answer. In a case where an operation of inputting an answer to the signage region is performed, the terminal device 200 may generate an instruction to add, to the message which is the distribution information, an answer to the message as the input information. In this case, the above-described update of the distribution information is addition of the answer to the distribution information. The answer may be made by at least one of text, image, voice, and the like. In this case, the input information is at least one of information such as text, image, and voice indicating an answer.

In a case where the input information receiving unit 120 receives input information, which is an instruction to add, to the message which is the distribution information, an answer to the message, the update unit 130 adds the answer, which is instructed to be added by the input information, to the message, which is the distribution information.

The signage region in which the distribution information of the message to which the answer is added is displayed may include a display of an interface for switching between a state of displaying the added answer and a state of not displaying the added answer. In a state where the answer is displayed, the signage region may be expanded, and the answer may be displayed in the expanded area.

In the first detailed example described above, in a case where the control unit 220 of the terminal device 200 receives, from the input unit 240, an input indicating an operation of switching to a state of di splaying an answer, the signage region may be expanded, and an answer may be displayed in the expanded region. In a case where the control unit 220 receives, from the input unit 240, an input indicating an operation of switching to a state of not displaying an answer, a process of deleting the expanded region may be performed.

In the second detailed example described above, in a case where the input information receiving unit 120 receives, from the input unit 240, the input information indicating the operation of switching to the state of displaying the answer, the update unit 130 updates the distribution information such that the signage region including the expanded region in which the answer is displayed is displayed. In a case where the input information receiving unit 120 receives, from the input unit 240, the input information indicating an operation of switching to a state of not displaying an answer, the update unit 130 updates the distribution information such that the signage region from which the expanded region has been erased is displayed.

### Second Specific Example

In a case where the distribution information is the above-described message and the input is an answer to the message, the input information may be an instruction to newly create distribution information that is an answer and associated with the distribution information as a message. In this case, the update of the distribution information instructed by the input information is to newly create distribution information that is an answer and associated with the distribution information as a message.

The distribution destination of the newly created distribution information that is an answer to the message may be designated by the user of the terminal device 200. In this case, the user of the terminal device 200 determines the distribution destination of the distribution information as an answer to the message by operating the signage region. The distribution information that is an answer to the message is associated with the distribution information of the message.

In this case, the terminal device 200 selected from the terminal devices 200 that can communicate with the information distribution control device 100 may be determined as the distribution destination by the user's operation. A user selected from users of the terminal device 200 that can communicate with the information distribution control device 100 may be determined as the distribution destination user by a user's operation. In a case where the distribution destination user is determined, the update unit 130 sets the distribution destination of the distribution information of the answer to the terminal device 200 associated with the distribution destination user. Information associating the distribution destination user with the terminal device 200 may be stored in the distribution information storage unit 140 in advance.

Also in this specific example, the signage region in which the distribution information of the message to which the answer is input is displayed may include a display of an interface for switching between a state of displaying the answer to the message and a state of not displaying the answer.

In the first detailed example described above, in a case where the control unit 220 of the terminal device 200 receives, from the input unit 240, an input indicating an operation of switching to a state of displaying an answer, the signage region may be expanded, and an answer may be displayed in the expanded region. In this case, the control unit 220 may generate input information for requesting distribution of the distribution information indicating an answer associated with the distribution information of the message displayed in the signage region. Then, the control unit 220 transmits the generated input information to the information distribution control device 100. The control unit 220 receives the distribution information indicating the answer distributed from the information distribution control device via the information receiving unit 210, and displays the received distribution information indicating the answer in the expanded region. In a case where the control unit 220 receives, from the input unit 240, an input indicating an operation of switching to a state of not displaying an answer, a process of deleting an expanded region is performed.

In the second detailed example described above, in a case where the input information receiving unit 120 receives, from the input unit 240, the input information indicating the operation of switching to the state of displaying the answer, the update unit 130 updates the distribution information such that the signage region including the expanded region in which the answer is displayed is displayed. In this case, the update unit 130 updates the distribution information of the message so that the answer (specifically, the answer to the distribution information of the answer in which the terminal device 200 is designated as the distribution destination, associated with the distribution information of the message) to the message is displayed in the expanded region. In a case where the input information receiving unit 120 receives, from the input unit 240, the input information indicating an operation of switching to a state of not displaying an answer, the update unit 130 updates the distribution information such that the signage region from which the expanded region has been erased is displayed.

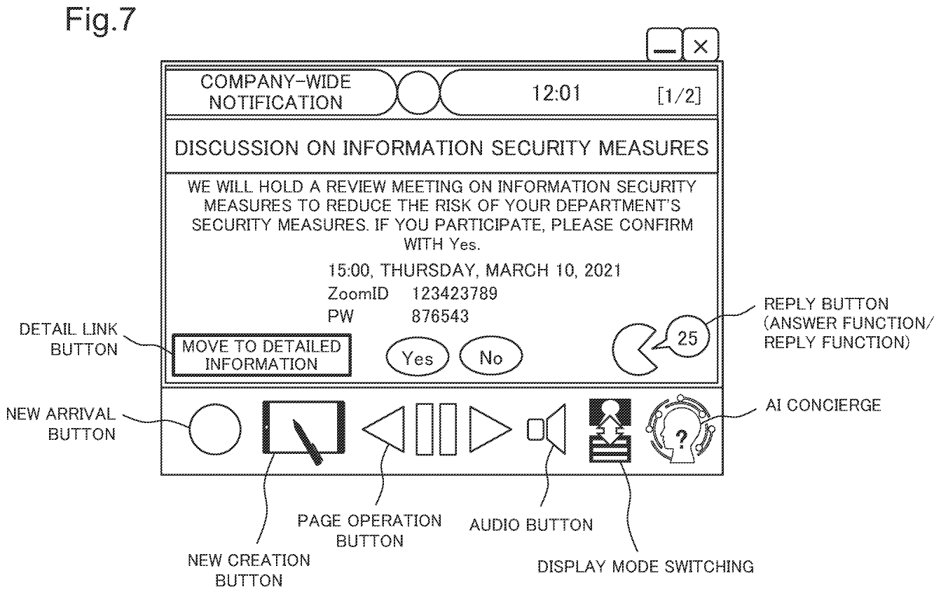

FIG. 7 is a diagram schematically illustrating signage regions in a first specific example and a second specific example; In FIG. 7, a detail link button is an interface for referring to (in other words, other distribution information including detailed information is designated as the selected distribution information) other distribution information including detailed information. A new arrival button is an interface that indicates existence and non-existence of new distribution information with a difference in color, and switches a display indicating that there is new distribution information to a display indicating that there is no new distribution information. A new creation button represents an interface for creating new distribution information. The interface for creating new distribution information will be described in detail later. A page operation button is used as an interface for giving an instruction to change the selected distribution information. For example, in a case where the triangle on the left side of the page operation button is operated, the distribution information before the distribution information selected as the selected distribution information in the column of the sorted distribution information is changed to the selected distribution information. For example, in a case where the triangle on the right side of the page operation button is operated, the distribution information after the distribution information selected as the selected distribution information in the column of the sorted distribution information is changed to the selected distribution information.

An audio button indicates whether the distribution information includes audio data (alternatively, whether the distribution information is associated with the distribution information of the audio data). In this case, for example, in a case where the distribution information includes audio data (alternatively, in a case where the distribution information is associated with the distribution information of the audio data), the audio button is displayed. In a case where the distribution information does not include the audio data (alternatively, in a case where the distribution information is not associated with the distribution information of the audio data), the audio button is not displayed. The operation of reproducing and stopping the audio data may be performed by a combination of the audio button and the page operation button. For example, an operation of clicking or tapping the right triangle in a state where the displayed audio button is selected may be an operation of instructing the start of reproduction of the audio data. For example, an operation of clicking or tapping the two rectangles at the center of the page operation button in a state where the audio data is being reproduced may be an operation of instructing to stop the reproduction of the audio data.

The “display mode switching” is an interface for switching between a state of displaying the list of the distribution information and a state of displaying the selected distribution information. The buttons of the AI concierge represent the guide interface described above.

In the example illustrated in FIG. 7, the “Yes” button and the “No” button are interfaces for answering the questionnaire. In a case where the input indicating that the operation to select the Yes button is performed is received, the control unit 220 generates input information indicating Yes associated with the selected distribution information, and transmits the generated input information to the information distribution control device 100 via the information transmitting unit 250. In a case where the control unit 220 receives an input indicating that the operation to select the No button has been performed, the control unit 220 generates input information indicating No associated with the selected distribution information, and transmits the generated input information to the information distribution control device 100 via the information transmitting unit 250. In this case, the update unit 130 may be configured to generate a summary result of the answers of the questionnaire received as the input information, and generate new distribution information in which the creator of the questionnaire is the distribution destination and which is the summary result of the questionnaire.

A reply button may be an interface for displaying an answer or a reply to the displayed message. The function of the reply button may be specified by the creator of the message.

For example, in a case where the function of the reply button is designated as an interface for creating an answer to a message that is a request for a questionnaire, the control unit 220 may display a screen for inputting an answer to the questionnaire when the reply button is operated. The control unit 220 generates input information indicating an answer to the questionnaire from the input information. The information displayed on the screen for inputting the answer to the questionnaire (in other words, a question) may be created by the creator of the message that is the questionnaire. Also in this case, the update unit 130 may be configured to generate a summary result of the answer of the questionnaire received as the input information, and generate new distribution information to which the creator of the questionnaire is the distribution destination and which is the summary result of the questionnaire.

In a case where the function of the reply button is designated as an interface for displaying a reply to a message, when the reply button is operated, the control unit 220 may expand the signage region and display an existing reply to the message in the expanded region. The control unit 220 may display an interface for creating a reply to the message in the expanded region. The interface for creating a reply to the message may be configured to be able to select a target for creating a new reply from the message of the selected distribution information and the existing reply. The interface for creating a reply to the message may be configured to be able to designate a distribution destination of a newly created reply. An interface for forwarding a target selected from the message and the reply may be displayed in the expanded region. The control unit 220 generates input information indicating a request for generating distribution information of a reply to the message from the input by the user, and transmits the generated input information to the information distribution control device 100. The update unit 130 of the information distribution control device 100 generates distribution information of a reply to the message. Then, the distribution unit 110 distributes the distribution information of the reply to the message to the designated distribution destination.

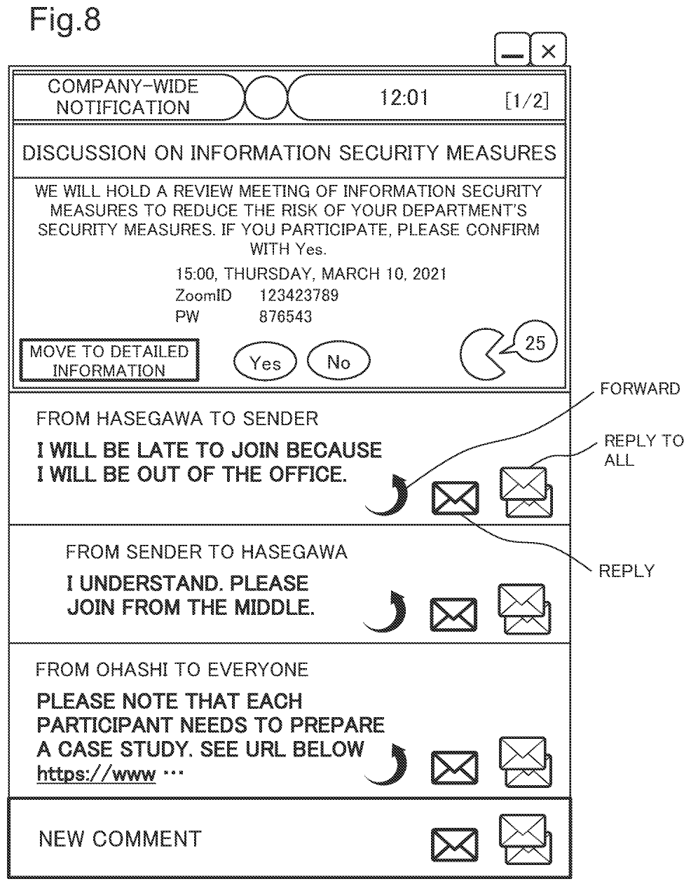

FIG. 8 is a diagram illustrating an example of a signage region in which a reply to a message is displayed; In the example illustrated in FIG. 8, the upper rectangle represents the signage region before being expanded. The lower signage region before being expanded represents an expanded region. A reply to the message displayed in the signage region before being expanded is displayed in the expanded region. The “forward” button displayed in each reply is an interface for transferring the reply. In a case where the “forward” button is operated, the control unit 220 displays a screen for selecting a forward destination, and generates input information indicating a request for generating distribution information of a reply in which the forward destination selected on the screen is designated as the distribution destination. The “reply” button displayed in each reply is an interface for creating a new reply to which the creator of the reply is designated as the distribution destination. In a case where the “reply” button is operated, the control unit 220 displays a screen for inputting the content of the reply. The control unit 220 receives the input reply, and generates input information indicating a request for generating distribution information of the input reply in which the terminal device 200 of the creator of the reply in which the operated “reply” button is displayed is designated as the distribution destination. In a case where the “reply all” button is operated, the control unit 220 similarly displays a screen for inputting the content of the reply and receives the input reply. Then, the control unit 220 generates input information indicating a request for generating distribution information of the input reply in which all the distribution destinations of the reply indicating the operated “reply all” button are designated as the distribution destinations.

In a case where the “reply” button in the rectangle written as “new comment” is operated, the control unit 220 displays a screen for inputting the content of the reply and receives the input reply. Then, the control unit 220 generates input information indicating a request for generating the distribution information of the input reply in which the terminal device 200 of the creator of the selected distribution information is designated as the distribution destination. In a case where the button of “replay all” in the rectangle written as “new comment” is operated, the control unit 220 displays a screen for inputting the content of a reply and receives the input reply. Then, the control unit 220 generates input information indicating a request for generating the distribution information of the input reply in which all the distribution destinations of the selected distribution information are designated as the distribution destinations.

### Third Specific Example

The distribution information may be a template for generating new distribution information. The template for generating the new distribution information may be created in advance and stored in the distribution information storage unit 140. The template may include an interface for inputting a content displayed as the distribution information for each predetermined item. The interface for inputting the content displayed as the distribution information may be an interface that allows a character string to be freely input. The interface for inputting the content displayed as the distribution information may be an interface for selecting one value from a plurality of preset values. The template may include an interface for associating other distribution information, reproduction target information, or the like with the distribution information. The template may include an interface for selecting whether to add an interface for inputting an answer to the questionnaire to the distribution information.

A plurality of templates may be created in advance and stored in the distribution information storage unit 140. The template may include an interface for selecting a template to be used from the plurality of templates.

The template may include an interface for selecting a distribution destination. The template may include an interface for setting a display period. The generated distribution information may be excluded from the distribution target when the set display period ends. In a case where the display period is set, for example, the distribution unit 110 does not distribute the distribution information whose distribution date and time is not included in the display period. The template may include an interface for setting a reference date. When the reference date is set, the generated distribution information is updated to include the date and time up to the reference date. For example, the update unit 130 updates, at a predetermined timing (for example, at a predetermined time), a portion indicating a period up to the reference date in the distribution information in which the reference date is set.

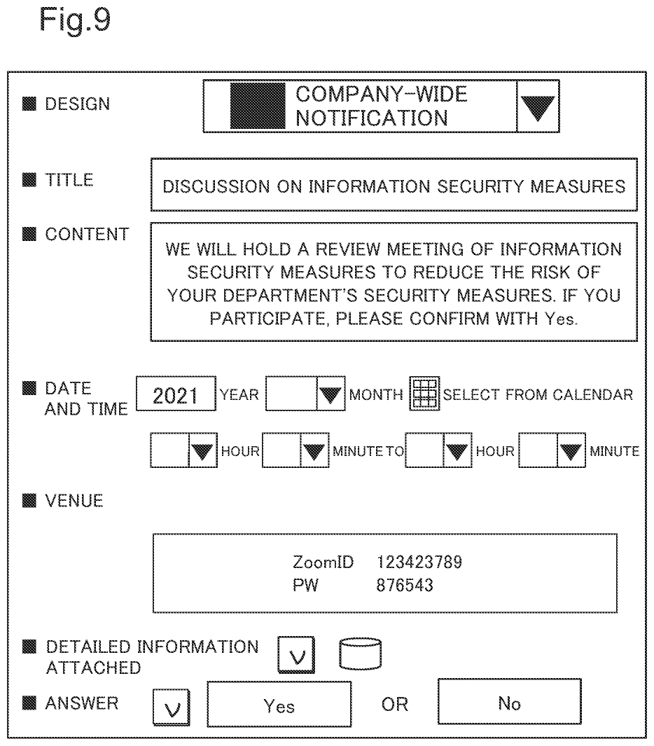

FIG. 9 is a diagram schematically illustrating an example of distribution information which is a template for generating new distribution information; In the example illustrated in FIG. 9, “design” is an interface for selecting the type of template. The right rectangle of the design is displayed as a pull-down menu. When a template of a type different from the displayed template is selected in the pull-down menu, the displayed template is switched to the selected template. For example, the control unit 220 switches the displayed template. In the second detailed example described above, the switching of the displayed template may be performed by the update unit 130, for example.

A rectangle on the right side of the title and the content is an interface for freely inputting the content. The text input to these rectangles is displayed as a part of the distribution information.

A pull-down menu or the like displayed on the right side of the “date and time” is an interface for setting the date and time of the meeting. The input date and time is displayed as a part of the distribution information.

The lower rectangle of “venue” is an interface for inputting a venue of a meeting. A text indicating the venue is input to the rectangle. In a case where an online meeting guide using Zoom (registered trademark) is created, Zoom ID, a password, and the like are input as text in this rectangle.

A check box on the right side of “attach detailed information” is an interface for designating whether to associate other distribution information with the generated distribution information. When the check box is checked, other distribution information is associated with the generated distribution information. When the check box is not checked, no other distribution information is associated with the generated distribution information.

A graph on the right side of the check box of “attach detailed information” is an interface for designating other distribution information. In a case where the graph on the right side of the check box of “attach detailed information” is clicked or tapped, for example, a menu for selecting a file stored in the storage device of the terminal device 200 is displayed. The selected file is transmitted from the terminal device 200 to the information distribution control device 100 as other distribution information associated with the generated distribution information. Specifically, the control unit 220 generates input information indicating a request for setting the selected file to other distribution information associated with the distribution information generated using the template, and transmits the generated input information to the information distribution control device 100. The generated input information is transmitted to the update unit 130 via the information transmitting unit 250 and the input information receiving unit 120. The update unit 130 generates other distribution information associated with the distribution information generated using the template in which the selected file is used, and stores the generated distribution information in the distribution information storage unit 140.

A check box on the right side of “answer” is an interface for setting whether the generated distribution information includes an interface for answering whether to attend the meeting. In a case where the check box on the right side of “answer” is checked, distribution information including an interface for answering whether to attend the meeting is generated. In a case where the check box on the right side of the “answer” is not checked, distribution information not including an interface for answering whether to attend the meeting is generated. The two rectangles on the right side of the check box represent an interface for inputting two character strings indicating options. In the generated distribution device, two character strings input to the two rectangles are displayed as character strings indicating options.

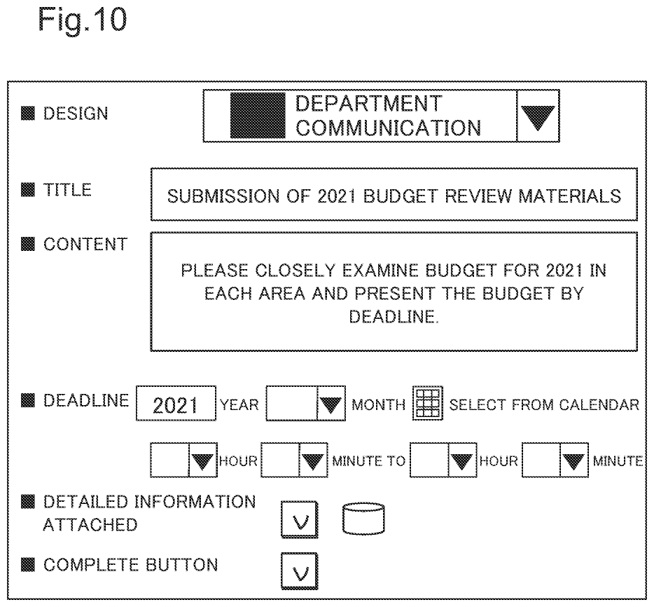

FIG. 10 is a diagram schematically illustrating another example of the distribution information which is a template for generating new distribution information; “Design”, “title”, “content”, and “attach detailed information” are the same as those in the example illustrated in FIG. 9. However, the type of template selected in the pull-down menu for “design” is different from the type of template illustrated in FIG. 9.

A pull-down menu or the like displayed on the right side of the “deadline” is an interface for setting an answer deadline of the questionnaire. The input answer deadline is displayed as a part of the distribution information.

A check box on the right side of the “completion button” is an interface for setting whether the distribution information generated using the template includes the “completion button” as an interface. In a case where the check box on the right side of the “completion button” is checked, distribution information including the “completion button” as an interface is generated. In a case where the check box on the right side of the “completion button” is not checked, the distribution information not including the “completion button” as the interface is generated.

The interface of the “completion button” included in the distribution information is an interface for switching the distribution information from the distribution information to be distributed to the distribution information not to be distributed. In this case, an attribute indicating whether the distribution information is to be distributed may be given to the distribution information. In a case where an input indicating an operation on the “completion button” in the signage region where the distribution information is displayed is received, the control unit 220 generates, for example, input information indicating a request to change the value of the attribute of the displayed distribution information from a value indicating that it is a distribution target to a value indicating that it is not a distribution target. The generated input information is transmitted to the update unit 130 via the information transmitting unit 250 and the input information receiving unit 120. When receiving such input information, the update unit 130 performs an update to change the value of the attribute of the displayed distribution information from a value indicating that it is a distribution target to a value indicating that it is not a distribution target.

In a case where the distribution request is not received from the terminal device 200, the distribution unit 110 does not distribute the distribution information in which the value of the attribute is set to a value indicating that it is not a distribution target.

For example, in a case where the input information receiving unit 120 receives, from the terminal device 200, a request for distribution of the distribution information in which the value of the attribute is set to a value indicating that the distribution is not to be performed, the distribution unit 110 transmits the distribution information to the terminal device 200 that has transmitted the request.

The template is not limited to the examples of FIGS. 9 and 10.

### Fourth Specific Example

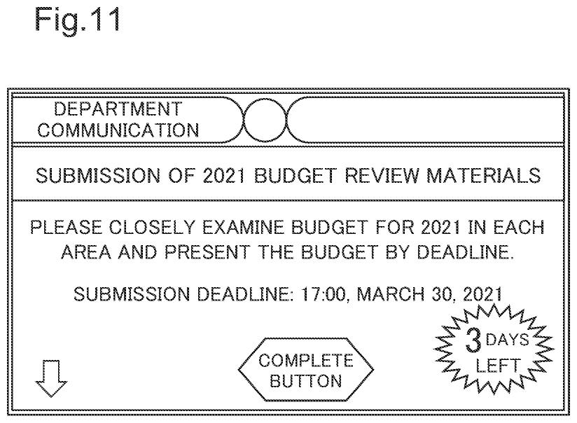

FIG. 11 is a diagram illustrating a specific example of the distribution information to be displayed; The example illustrated in FIG. 11 represents an example of the distribution information distributed to the terminal devices 200 of all the members belonging to a department.

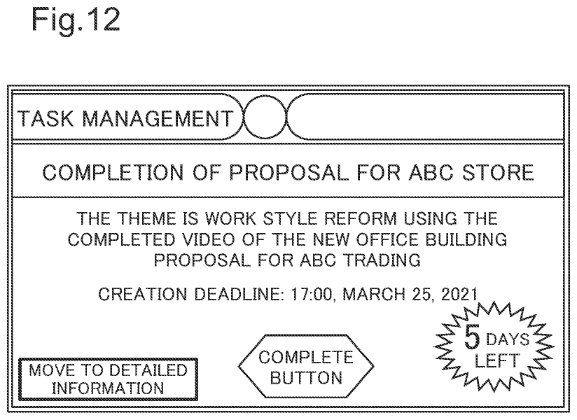

FIG. 12 is a diagram illustrating another specific example of the distribution information to be displayed; and The example illustrated in FIG. 12 represents an example of the distribution information distributed only to the terminal device 200 of the creator of the distribution information. The distribution information may be set to be displayed in different colors for each type. For example, the distribution information distributed only to the terminal device 200 of the creator of the distribution information illustrated in FIG. 12 may be displayed in a color different from the color of the distribution information distributed to the terminal devices 200 of all the members belonging to the department illustrated in FIG. 11.

In the example of FIG. 11, the period until the set deadline (in other words, the designated date and time) is displayed as “3 more days”. In the example of FIG. 12, the period until the set deadline is displayed as “5 more days”. For example, the update unit 130 may update the distribution information for which a deadline is set at a predetermined time (for example, 0:00 AM) according to the length until the set deadline (in other words, the designated date and time). Specifically, for example, the update unit 130 may update the distribution information in which the deadline is set so as to include information indicating the length up to the set deadline.

### Other Example Embodiments

Each of the information distribution control device 10, the information distribution control device 100, and the terminal device 200 described above can be achieved by a computer including a processor that executes a program loaded from a storage medium into a memory. Each of the information distribution control device 10, the information distribution control device 100, and the terminal device 200 can also be achieved by dedicated hardware. Each of the information distribution control device 10, the information distribution control device 100, and the terminal device 200 can also be achieved by a combination of the above-described computer and dedicated hardware.

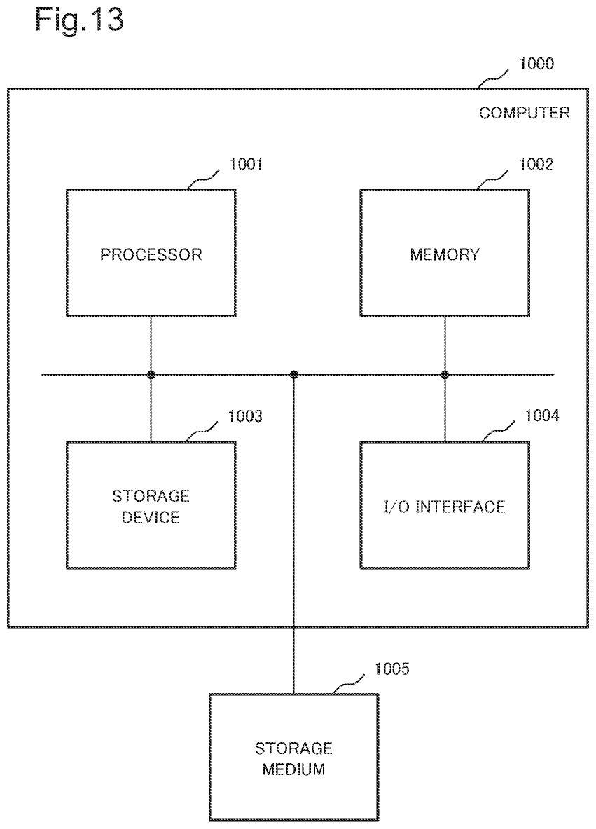

FIG. 13 is a diagram illustrating an example of a hardware configuration of a computer 1000 that can achieve the information distribution control device and the terminal device according to the example embodiments of the present disclosure. In the example of FIG. 13, the computer 1000 includes a processor 1001, a memory 1002, a storage device 1003, and an input/output (I/O) interface 1004. The computer 1000 can access a storage medium 1005. The memory 1002 and the storage device 1003 are, for example, storage devices such as a random access memory (RAM) and a hard disk. The storage medium 1005 is, for example, a storage device such as a RAM or a hard disk, a read only memory (ROM), or a portable storage medium. The storage device 1003 may be the storage medium 1005. The processor 1001 can read and write data and programs from and in the memory 1002 and the storage device 1003. The processor 1001 can access, for example, a device connected to the communication network 300 via the I/O interface 1004. The processor 1001 may access the storage medium 1005. The storage medium 1005 stores a program for operating the computer 1000 as the information distribution control device according to the example embodiments of the present disclosure or a program for operating the computer 1000 as the terminal device according to the example embodiments of the present disclosure.

The processor 1001 loads a program, which is stored in the storage medium 1005 and causes the computer 1000 to operate as the information distribution control device according to the example embodiments of the present disclosure, into the memory 1002. Then, when the processor 1001 executes the program loaded in the memory 1002, the computer 1000 operates as the information distribution control device according to the example embodiments of the present disclosure.

The processor 1001 loads a program, which is stored in the storage medium 1005 and causes the computer 1000 to operate as the terminal device according to the example embodiments of the present disclosure, into the memory 1002. Then, when the processor 1001 executes the program loaded in the memory 1002, the computer 1000 operates as a terminal device according to the example embodiments of the present disclosure.

The distribution unit 110, the input information receiving unit 120, the update unit 130, the information receiving unit 210, the control unit 220, the output unit 230, the input unit 240, and the information transmitting unit 250 can be achieved by, for example, the processor 1001 that executes a program loaded in the memory 1002. The distribution information storage unit 140 can be achieved by the memory 1002 included in the computer 1000 or the storage device 1003 such as a hard disk device. Alternatively, some or all of the distribution unit 110, the input information receiving unit 120, the update unit 130, the distribution information storage unit 140, the information receiving unit 210, the control unit 220, the output unit 230, the input unit 240, and the information transmitting unit 250 can be achieved by a dedicated circuit that achieves the functions of the units.

A general digital signage is achieved by a display device such as a large display, a set top box connected to the display device, and a management computer that distributes information to be displayed on the display device to the set top box. Then, the set top box displays the information distributed from the management computer on the display device.

In the digital signage system of JP 2015-225612 A, the resident who has received the bulletin information can input answer information to the bulletin information, but cannot newly create or update the bulletin information.

One example of the effect of the present disclosure is that the distribution information can be updated on the side of the device that receives the distribution information to be distributed.

Some or all of the above example embodiments may be described as the following supplementary notes, but are not limited to the following.

### Supplementary Note 1

An information distribution control device comprising:

a distribution means configured to distribute, to a terminal device, distribution information in which the terminal device is designated as a distribution destination, terminal device displaying the received distribution information in a signage region included in a display screen;

an input information receiving means configured to receive input information indicating an input to the signage region; and

an update means configured to update the distribution information according to the input information, in which

the distribution means is configured to distribute the updated distribution information to a terminal device designated as a distribution destination of the distribution information.

### Supplementary Note 2

The information distribution control device according to Supplementary Note 1, in which

the input information receiving means is further configured to receive information of a distribution destination of the input information,

the update means is configured to update the distribution information transmitted to the distribution destination according to the input information, and

the distribution means is configured to distribute the updated distribution information to the terminal device designated as the distribution destination of the updated distribution information.

### Supplementary Note 3

The information distribution control device according to Supplementary Note 1 or 2, in which

the distribution information includes request distribution information distributed according to a distribution request and information indicating presence of the request distribution information,

the distribution means is configured to distribute the distribution information other than the request distribution information when the distribution request is not received,

the input information receiving means is configured to receive the distribution request as the input information, and

the distribution means is configured to, when the distribution request is received, distribute the requested distribution information requested by the distribution request.

### Supplementary Note 4

The information distribution control device according to Supplementary Note 3, in which

the input information receiving means is configured to receive, as the input information, a change request indicating a request for changing the distribution information to the requested distribution information, and

the update means is configured to change the distribution information requested to be changed to the request distribution information by the change request to the request distribution information.

### Supplementary Note 5

The information distribution control device according to any one of Supplementary Notes 1 to 4, in which

the input information receiving means is configured to receive, as the input information, a stop instruction for instructing to stop distribution of the distribution information being distributed, and

the distribution means is configured to stop distribution of the distribution information when receiving the stop instruction.

### Supplementary Note 6

The information distribution control device according to any one of Supplementary Notes 1 to 5, in which

the distribution means is configured to distribute a template of distribution information as the distribution information,

the input information receiving means is configured to receive, as the input information, new distribution information generated using the template, and

the distribution means is configured to distribute the received new distribution information to the terminal device designated as a distribution destination of the new distribution information.

### Supplementary Note 7

The information distribution control device according to Supplementary Note 6, in which

the distribution means is configured to distribute a plurality of types of the templates, and

the input information receiving means is configured to receive, as the input information, the new distribution information generated using a selected template among the plurality of types of the templates.

### Supplementary Note 8

The information distribution control device according to any one of Supplementary Notes 1 to 7, in which

the input information receiving means is configured to receive, as the input information, distribution information including information of designated date and time,

the update means is configured to update the distribution information including the designated date and time according to a length of time until the designated date and time, and

the distribution means is configured to distribute the updated distribution information to the terminal device designated as a distribution destination of the distribution information.

### Supplementary Note 9

An information distribution system including:

the terminal device; and

the information distribution control device according to any one of Supplementary Notes 1 to 8.

### Supplementary Note 10

An information distribution control method including:

distributing, to a terminal device, distribution information in which the terminal device is designated as a distribution destination, the terminal device displaying the received distribution information in a signage region included in a display screen;

receiving input information indicating an input to the signage region;

updating the distribution information according to the input information; and

distributing the updated distribution information to a terminal device designated as a distribution destination of the distribution information.

### Supplementary Note 11

The information distribution control method according to Supplementary Note 10, further including:

receiving information of a distribution destination of the input information;

updating the distribution information transmitted to the distribution destination according to the input information; and

distributing the updated distribution information to the terminal device designated as the distribution destination of the updated distribution information.

### Supplementary Note 12

The information distribution control method according to Supplementary Note 10 or 11, in which

the distribution information includes request distribution information distributed according to a distribution request and information indicating presence of the request distribution information,

the distribution information other than the request distribution information is distributed when the distribution request is not received,

the distribution request is received as the input information, and

when the distribution request is received, the request distribution information requested by the distribution request is distributed.

### Supplementary Note 13

The information distribution control method according to Supplementary Note 12, including:

receiving, as the input information, a change request indicating a request for changing the distribution information to the requested distribution information; and

updating the distribution information requested to be changed to the requested distribution information by the change request to the requested distribution information.

### Supplementary Note 14

The information distribution control method according to any one of Supplementary Notes 10 to 13, including:

receiving, as the input information, a stop instruction for instructing to stop distribution of the distribution information being distributed; and

stopping distribution of the distribution information when the stop instruction is received.

### Supplementary Note 15

The information distribution control method according to any one of Supplementary Notes 10 to 14, including:

distributing a template of distribution information as the distribution information;

receiving, as the input information, new distribution information generated using the template; and

distributing the received new distribution information to the terminal device designated as a distribution destination of the new distribution information.

### Supplementary Note 16

The information distribution control method according to Supplementary Note 15, including:

delivering a plurality of types of the templates; and

receiving, as the input information, the new distribution information generated using a selected template among the plurality of types of the templates.

### Supplementary Note 17

The information distribution control method according to any one of Supplementary Notes 10 to 16, including:

receiving, as the input information, distribution information including information of designated date and time;

updating the distribution information including the designated date and time according to a length of time until the designated date and time; and

distributing the updated distribution information to the terminal device designated as a distribution destination of the distribution information.

### Supplementary Note 18

A program causing a computer to execute:

a distribution process of distributing, to a terminal device, distribution information in which the terminal device is designated as a distribution destination, the terminal device displaying the received distribution information in a signage region included in a display screen;

an input information receiving process of receiving input information indicating an input to the signage region; and

an updating process of updating the distribution information according to the input information, wherein

the distribution process includes distributing the updated distribution information to a terminal device designated as a distribution destination of the distribution information.

### Supplementary Note 19

The program according to Supplementary Note 18, in which

the input information receiving process further includes receiving information of a distribution destination of the input information,

the updating process includes updating the distribution information transmitted to the distribution destination according to the input information, and

the distribution process includes distributing the updated distribution information to the terminal device designated as the distribution destination of the updated distribution information.

### Supplementary Note 20

The program according to Supplementary Note 18 or 19, in which

the distribution information includes request distribution information distributed according to a distribution request and information indicating presence of the request distribution information,

the distribution process includes distributing the distribution information other than the request distribution information when the distribution request is not received,

the input information receiving process includes receiving the distribution request as the input information, and

the distribution process includes, when the distribution request is received, distributing the requested distribution information requested by the distribution request.

### Supplementary Note 21

The program according to Supplementary Note 20, in which

the input information receiving process includes receiving, as the input information, a change request indicating a request for changing the distribution information to the requested distribution information, and

the updating process includes changing the distribution information requested to be changed to the request distribution information by the change request to the request distribution information.

### Supplementary Note 22

The program according to any one of Supplementary Notes 18 to 21, in which

the input information receiving process includes receiving, as the input information, a stop instruction for instructing to stop distribution of the distribution information being distributed, and

the distribution process includes stopping distribution of the distribution information when receiving the stop instruction.

### Supplementary Note 23

The program according to any one of Supplementary Notes 18 to 22, in which

the distribution process includes distributing a template of distribution information as the distribution information,

the input information receiving process includes receiving new distribution information generated using the template as the input information; and

the distribution process includes distributing the received new distribution information to the terminal device designated as a distribution destination of the new distribution information.

### Supplementary Note 24

The program according to Supplementary Note 23, in which

the distribution process includes distributing a plurality of types of the templates, and

the input information receiving process includes receiving, as the input information, the new distribution information generated using a selected template among the plurality of types of the templates.

### Supplementary Note 25

The program according to any one of Supplementary Notes 18 to 20 24, in which

the input information receiving process includes receiving distribution information including information of designated date and time as the input information,

the updating process includes updating the distribution information including the designated date and time according to a length of time until the designated date and time, and

the distribution process includes distributing the updated distribution information to the terminal device designated as a distribution destination of the distribution information.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed disclosure even if the claims are amended during prosecution.

What is claimed is:

1. An information distribution control device comprising:
at least one memory configured to store instructions; and
at least one processor configured to execute the instructions to:
distribute, to a terminal device, distribution information in which the terminal device is designated as a distribution destination, the terminal device displaying the received distribution information in a signage region included in a display screen;
receive input information indicating an input to the signage region;
update the distribution information according to the input information; and
distribute the updated distribution information to a terminal device designated as a distribution destination of the distribution information.

2. The information distribution control device according to claim 1, wherein
the at least one processor is further configured to execute the instructions to:
receive information of a distribution destination of the input information:
update the distribution information transmitted to the distribution destination according to the input information; and
distribute the updated distribution information to the terminal device designated as the distribution destination of the updated distribution information.

3. The information distribution control device according to claim 1, wherein
the distribution information includes request distribution information distributed according to a distribution request and information indicating presence of the request distribution information, and
the at least one processor is further configured to execute the instructions to:
distribute the distribution information other than the request distribution information when the distribution request is not received;
receive the distribution request as the input information; and
when the distribution request is received, distribute the requested distribution information requested by the distribution request.

4. The information distribution control device according to claim 3, wherein
the at least one processor is further configured to execute the instructions to:
receive, as the input information, a change request indicating a request for changing the distribution information to the requested distribution information; and
change the distribution information requested to be changed to the request distribution information by the change request to the request distribution information.

5. The information distribution control device according to claim 1, wherein
the at least one processor is further configured to execute the instructions to:
receive, as the input information, a stop instruction for instructing to stop distribution of the distribution information being distributed; and
stop distribution of the distribution information when receiving the stop instruction.

6. The information distribution control device according to claim 1, wherein
the at least one processor is further configured to execute the instructions to:
distribute a template of distribution information as the distribution information;
receive, as the input information, new distribution information generated using the template; and
distribute the received new distribution information to the terminal device designated as a distribution destination of the new distribution information.

7. The information distribution control device according to claim 6, wherein
the at least one processor is further configured to execute the instructions to:
distribute a plurality of types of the templates; and
receive, as the input information, the new distribution information generated using a selected template among the plurality of types of the templates.

8. The information distribution control device according to claim 1, wherein
the at least one processor is further configured to execute the instructions to:
receive, as the input information, distribution information including information of designated date and time;
update the distribution information including the designated date and time according to a length of time until the designated date and time; and
distribute the updated distribution information to the terminal device designated as a distribution destination of the distribution information.

9. An information distribution control method comprising:
distributing, to a terminal device, distribution information in which the terminal device is designated as a distribution destination, the terminal device displaying the received distribution information in a signage region included in a display screen;
receiving input information indicating an input to the signage region;
updating the distribution information according to the input information; and
distributing the updated distribution information to a terminal device designated as a distribution destination of the distribution information.

10. The information distribution control method according to claim 9, further comprising:
receiving information of a distribution destination of the input information:
updating the distribution information transmitted to the distribution destination according to the input information; and
distributing the updated distribution information to the terminal device designated as the distribution destination of the updated distribution information.

11. The information distribution control method according to claim 9, wherein
the distribution information includes request distribution information distributed according to a distribution request and information indicating presence of the request distribution information, and
the information distribution control method further comprises:
distributing the distribution information other than the request distribution information when the distribution request is not received;
receiving the distribution request as the input information; and
when the distribution request is received, distributing the requested distribution information requested by the distribution request.

12. The information distribution control method according to claim 11, further comprising:
receiving, as the input information, a change request indicating a request for changing the distribution information to the requested distribution information; and
changing the distribution information requested to be changed to the request distribution information by the change request to the request distribution information.

13. The information distribution control method according to claim 9, further comprising:
receiving, as the input information, a stop instruction for instructing to stop distribution of the distribution information being distributed; and
stopping distribution of the distribution information when receiving the stop instruction.

14. The information distribution control method according to claim 9, further comprising:
distributing a template of distribution information as the distribution information;
receiving, as the input information, new distribution information generated using the template; and
distributing the received new distribution information to the terminal device designated as a distribution destination of the new distribution information.

15. The information distribution control method according to claim 14, further comprising:
distributing a plurality of types of the templates; and
receiving, as the input information, the new distribution information generated using a selected template among the plurality of types of the templates.

16. The information distribution control method according to claim 9, further comprising:
receiving, as the input information, distribution information including information of designated date and time;
updating the distribution information including the designated date and time according to a length of time until the designated date and time; and
distributing the updated distribution information to the terminal device designated as a distribution destination of the distribution information.

17. A non-transitory computer readable storage medium storing a program causing a computer to execute:
distribution processing of distributing, to a terminal device, distribution information in which the terminal device is designated as a distribution destination, the terminal device displaying the received distribution information in a signage region included in a display screen;
input information receiving processing of receiving input information indicating an input to the signage region; and
updating processing of updating the distribution information according to the input information, wherein
the distribution processing includes distributing updated distribution information to a terminal device designated as a distribution destination of the distribution information.
